(19) United States
(12) Patent Application Publication
(10) Pub. No.: US 2005/0274131 A1
(43) Pub. Date: Dec. 15, 2005

(54) Air conditioner

(75) Inventors: Min Chul Cho, Changwon-si (KR); Jong Ho Lee, Gimhae-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/150,186

(22) Filed: Jun. 13, 2005

(30) Foreign Application Priority Data
Jun. 14, 2004 (KR) P2004-0043631
Jun. 14, 2004 (KR) P2004-0043632
Jun. 14, 2004 (KR) P2004-0043633

(51) Int. Cl. F25D 23/12; G01K 13/00

(52) U.S. Cl. 62/129

(57) ABSTRACT

An air conditioner is disclosed. The present invention includes an input part to which a control signal for an operation of the air conditioner is inputted, a display part having at least one sub-display part displaying an operational state of the air conditioner, and a microcomputer controlling the air conditioner to be operated according to the control signal generated from the input part, the microcomputer controlling the operational state of the air conditioner to be displayed via the display part.

This application claims the benefit of the Korean Patent Application Nos. P2004-043631, P2004-043632 and P2004-043633, filed on Jun. 14, 2005, which are hereby incorporated by reference as if fully set forth herein.

### BACKGROUND OF THE INVENTION

1. Field of the Invention

The present invention relates to an air conditioner. Although the present invention is suitable for a wide scope of applications, it is particularly suitable for checking an operational state and setup items of the air conditioner with ease.

2. Discussion of the Related Art

Generally, an air conditioner consists of a compressor, a condenser, an expansion valve, and an evaporator, to provide a more pleasant indoor environment to a user. And, the air conditioner is a device for cooling/heating an indoor space or purifying air using a phase change of a refrigerant according to a thermodynamic cycle. Moreover, the air conditioner can be categorized into a separate type and a combined type.

The separate type air conditioner consists of an indoor unit, an outdoor unit, and a refrigerant pipe connecting the indoor and outdoor units together, in which the indoor and outdoor units are separated from each other for installation. The combined type air conditioner consists of an indoor unit, an outdoor unit, and a case receiving the indoor and outdoor units therein to be installed on a window and the like.

Meanwhile, both of the indoor and outdoor units of the combined type air conditioner are provided with the case having a relatively small volume. Hence, the combined type air conditioner needs an efficient configuration. In particular, a control panel for selecting and displaying an operational state of the air conditioner needs to be installed in a relatively small space on an outside of the case. And, it is necessary to facilitate a selection of the operational state via the control panel.

### SUMMARY OF THE INVENTION

Accordingly, the present invention is directed to an air conditioner that substantially obviates one or more problems due to limitations and disadvantages of the related art.

An object of the present invention is to provide an air conditioner, by which a control panel is enhanced.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an air conditioner according to the present invention includes an input part to which a control signal for an operation of the air conditioner is inputted, a display part having at least one sub-display part displaying an operational state of the air conditioner, and a microcomputer controlling the air conditioner to be operated according to the control signal generated from the input part, the microcomputer controlling the operational state of the air conditioner to be displayed via the display part.

Preferably, the at least one sub-display part includes a plurality of LEDs and each of the LEDs is turned on to correspond to the operational state of the air conditioner. Preferably, the LEDs are sequentially turned on according to the operational state of the air conditioner.

Preferably, the air conditioner further includes a remote controller receiving part receiving the control signal transmitted from a remote controller. Preferably, the microcomputer includes an input control part controlling the operation of the air conditioner according to the control signal transferred from at least one of the input part and the remote controller receiving part and a display control part controlling the operational state of the air conditioner to be displayed via the display part.

Preferably, the display part includes a temperature sub-display part displaying a temperature of a blown air set in the air conditioner, a time sub-display part displaying a reservation time set in the air conditioner, and an operational mode sub-display part displaying an operational mode set in the air conditioner. Preferably, the input part includes at least one button and the input part is controlled to change the operational state of the air conditioner according to a count of pressing the button.

Preferably, the input part includes a temperature adjusting part operated to control a temperature of an air blown from the air conditioner and an operational mode part operated to control a blow airflow rate and power supply of the air conditioner.

More preferably, the temperature adjusting part includes a thermostat operated to control the temperature by being rotated. And, the operational mode part includes a slide switch allowing the operation of the air conditioner to be selected.

Preferably, the operational mode part includes a fan regulating part operated to control a rotational speed of a fan for controlling an airflow rate blown into an indoor space and a power supply part operated to turn on/off a power supply to the air conditioner. More preferably, each of the power supply part and the fan regulating part includes a rocker switch. More preferably, if the power supply part is turned on, the fan is driven at either a high step or a low step.

In another aspect of the present invention, an air conditioner includes a temperature adjusting part operated to adjust a current supplied to a compressor for a control of an air blown from the air conditioner and a selection of a blower function and an operational mode part operated to control a blown airflow rate and a power supply of the air conditioner.

Preferably, the temperature adjusting part includes a thermostat operated to control the temperature by being rotated. Preferably, the operational mode part includes a slide switch slidable to allow the operation of the air conditioner to be selected. More preferably, the operational mode part includes a fan regulating part operated to control a rotational speed of a fan for controlling an airflow rate blown into an indoor space and a power supply part operated to turn on/off a power supply to the air conditioner. More preferably, each of the power supply part and the fan regulating part includes a rocker switch. More preferably, if the power supply part is turned on, the fan is driven at either a high step or a low step.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective diagram of an air conditioner according to the present invention;

FIG. 2 is a layout of a control panel according to a first embodiment of the present invention;

FIG. 3 is a block diagram of a control part according to a second embodiment of the present invention;

FIG. 4 is a layout of a control panel according to a second embodiment of the present invention;

FIG. 5 is a layout of an input part of a control panel according to a third embodiment of the present invention;

FIG. 6 is a circuit diagram of an air conditioner according to a third embodiment of the present invention; and

FIG. 7 is a layout of an input part of a control panel according to a fourth embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

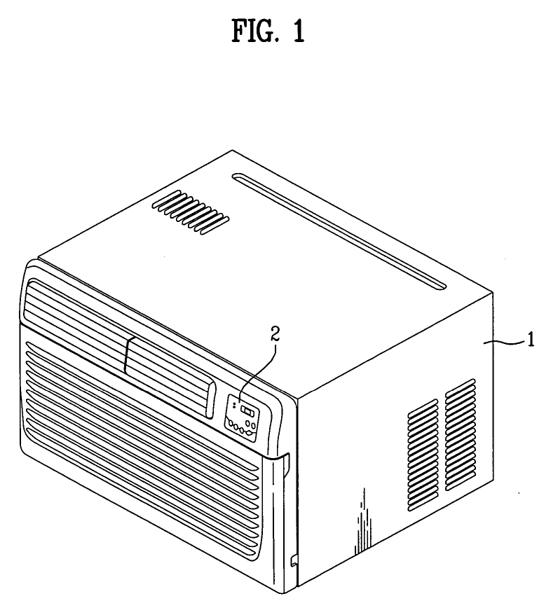

FIG. 1 is a perspective diagram of an air conditioner according to the present invention.

Referring to FIG. 1, an air conditioner 1 according to the present invention includes an indoor unit, an outdoor unit, and a case within which the indoor and outdoor units are provided to configure a combined type air conditioner. In particular, indoor air is conditioned by the indoor unit provided to a front side and heat exchange is carried out by the outdoor unit provided to a rear side.

Meanwhile, a control panel 2 is provided to one side of the case to control an operation of the air conditioner 1. Specifically, a signal for controlling the operation of the air conditioner 1 is inputted via the control panel 2. And, the inputted signal is transferred to a microcomputer (not shown in the drawing). The microcomputer controls the air conditioner 1 to be operated according to the inputted signal.

Hence, the microcomputer controls a compressor, fan and expansion valve provided within the air conditioner 1. In doing so, as the compressor is selectively operated, a refrigerant circulates according to a thermodynamic cycle so that the indoor air can be conditioned by the heat exchange with an indoor heat exchanger.

An air conditioner according to a first embodiment of the present invention is explained as follows.

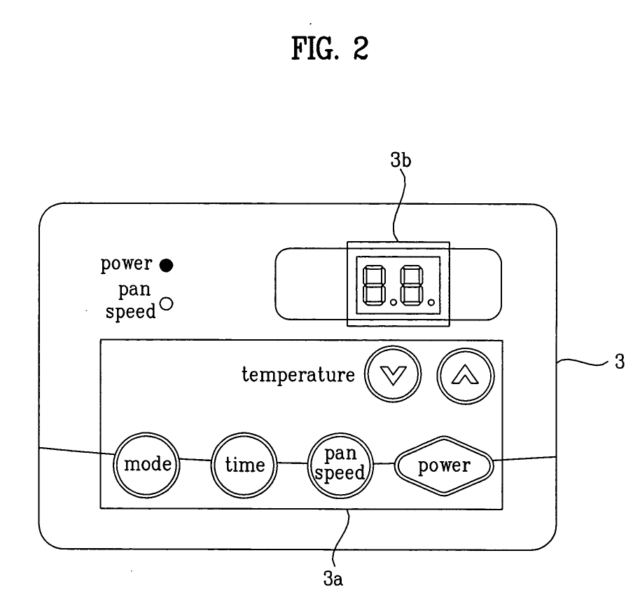

FIG. 2 is a layout of a control panel according to a first embodiment of the present invention.

Referring to FIG. 2, a control panel according to a first embodiment of the present invention includes a button part 2a and a display part 2b. The button part 2a includes at least one button for setting an operation of the air conditioner 1. Through the display part 2b, an operation state of the air conditioner 1 such as a temperature, time, operation mode and the like is displayed.

In this case, the display part 2b represents the temperature or time in a manner of displaying numbers with a combination of a plurality of segments. Hence, the display part 2b is just capable of representing one setup among the temperature, fan speed and operational mode of the air conditioner 1 but fails in displaying the operational state at the same time. Namely, the display part 2b basically displays the temperature. In case of attempting to check the fan speed or time setup, the button of the button part 2a is pressed to display the time or fan speed.

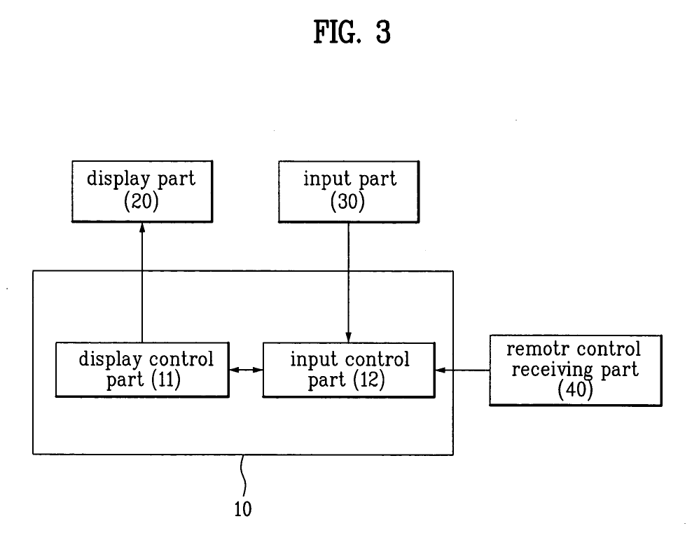

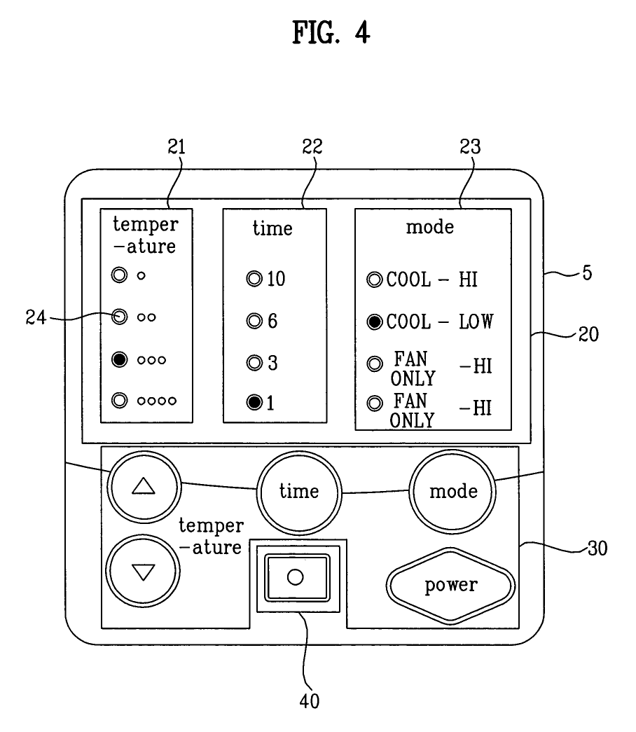

An air conditioner according to a second embodiment of the present invention is explained with reference to FIG. 3 and FIG. 4 as follows.

FIG. 3 is a block diagram of a control part according to a second embodiment of the present invention and FIG. 4 is a layout of a control panel according to a second embodiment of the present invention.

Referring to FIG. 3 and FIG. 4, a control panel of an air conditioner according to a second embodiment of the present invention preferably includes an input part 30, a remote controller receiving part 40, a display part 20, and a microcomputer 10.

The input part 30 preferably includes at least one button to set up an operation. A user operates the button of the input part 30 so set up the temperature, operating time, reservation time and operational mode of the air conditioner. If one of the buttons of the input part 30 is operated, it is preferable that the setup corresponding to the operation is activated and that the operational state of the air conditioner is changed according to a count of pressing the button.

The remote controller receiving part 40 receives a control signal transmitted from a remote controller that controls an operation of the air conditioner in a remote plate. The control signal is received by the remote controller receiving part 40 via an infrared communication system to be delivered to an input control part 12.

The display part 20 represents the operational state of the air conditioner and includes at least one or more sub-display parts 21, 22 and 23 to display all operational states of the air conditioner.

In particular, the display part 20 preferably includes the sub-display parts 21, 22 and 23 according to the temperature, time and operational mode, respectively. In this case, the temperature sub-display part 21 displays a blown-air temperature set up in the air conditioner. The temperature sub-display part 22 displays the reservation time set up for the activation of the air conditioner. And, the operational mode sub-display part 23 displays the operational mode of the air conditioner such as cooling, heating, airflow rate, rotational speed of a fan and the like.

Each of the sub-display parts 21, 22 and 23 includes a plurality of LEDs (light-emitting diodes) 24 that will be preferably turned on to correspond to the operational state of the air conditioner. In this case, according to the operational state of the air conditioner, the LEDs 24 of each of the sub-display parts 21, 22 and 23 can be sequentially or cumulatively turned on.

Meanwhile, the microcomputer 10 controls the air conditioner to operate according to the control signal transferred from at least one of the input part 30 and the remote controller receiving part 40. It is a matter of course that the microcomputer 10 controls the operational state of the air conditioner to be displayed via the display part 20.

In particular, the microcomputer preferably includes an input control part 12 and a display control part 11.

The input control part 12 senses and decides the control signal transferred from at least one of the input part 30 and the remote controller receiving part 40 to control the operation of the air conditioner according to the corresponding signal.

And, the display control part 11 controls the operational state of the air conditioner according to the control signal to be displayed via the display part 20.

In particular, each of the sub-display parts 21, 22 and 23 is controlled by the display control part 11 to display the setup state of the air conditioner step by step.

For instance, the temperature of the blown air of the air conditioner is divided into four steps according to the setup state in the input control part 12 and the temperature sub-display part 21 includes the LEDs corresponding to the number of the steps. The time sub-display part 22 divides the driven time of the air conditioner into four steps including 1-hour, 3-hours, 6-hours and 10-hours for example to have the LEDs corresponding to the number of the steps. Hence, in case that the LED corresponding to the 1-hour is turned on, the air conditioner is driven during one hour to stop being driven. The operational mode sub-display part 23 divides the operation mode into a case of blowing air-conditioned air and a case of circulating air to display. And, the operational mode sub-display part 23 the rotational speed of the fan according to the air conditioning step by step using the LEDs 24.

In doing so, the display control part 11 controls the LEDs 24 to be selectively turned on. Namely, the display control part 11 preferably turns on one of a plurality of the LEDs 24 step by step according to the setup state of the temperature, time or operational mode. In particular, the display control part 11 preferably controls the display part 20 to turn on the LEDs sequentially according to each step whenever the button of the input part 30 is repeatedly operated.

If the setup for the operation of the air conditioner is changed according to the control signal delivered via the input part 30 or the remote controller receiving part 40, it is preferable that the microcomputer 10 is turned on and off during a prescribed duration.

As mentioned in the foregoing description, the display part 20 of the air conditioner according to the present invention includes the sub-display parts 21, 22 and 23 having a plurality of the LEDs 24 each according to the temperature, the time and the operational mode, respectively, and is controlled to turn on a specific one of the LEDs for each step to display the corresponding setup state. Hence, it is able to display the overall states of the air conditioner without separate button operations.

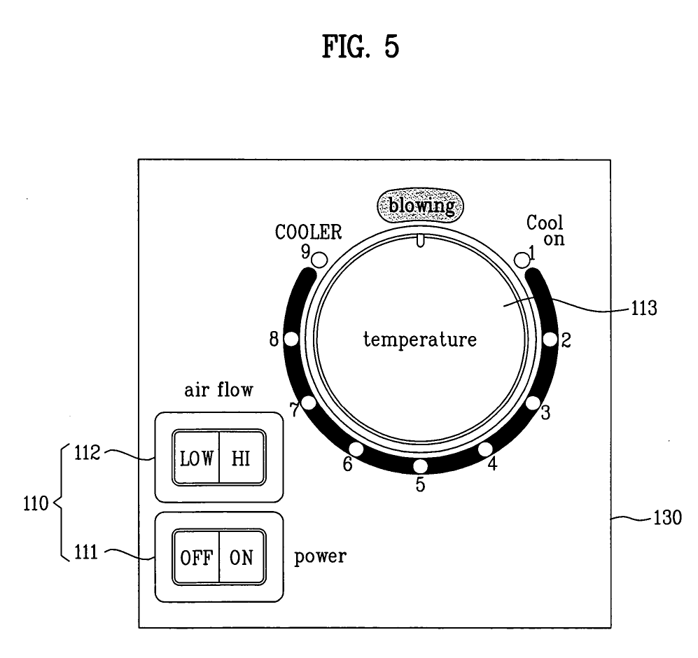

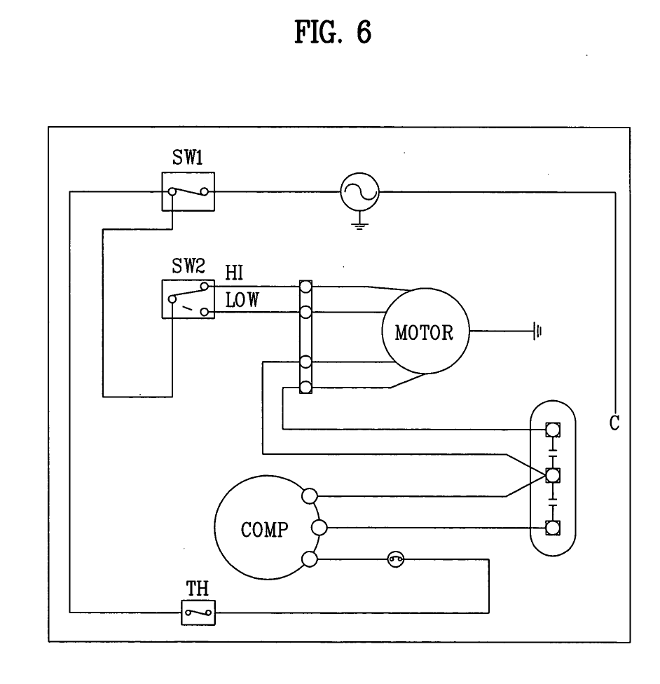

An air conditioner according to a third embodiment of the present invention is explained with reference to FIG. 5 and FIG. 6 as follows.

FIG. 5 is a layout of an input part of a control panel according to a third embodiment of the present invention and FIG. 6 is a circuit diagram of an air conditioner according to a third embodiment of the present invention.

Referring to FIG. 5, an input part 130 provided to a control panel according to a third embodiment of the present invention includes a temperature adjusting part 113 and an operational mode part 110.

The temperature adjusting part 113 is to control a temperature of air blown from the air conditioner. By operating the temperature adjusting part 113, it is able to perform a function of adjusting the temperature of the blown air but also a circulating function of circulating indoor air by driving a fan only in case of turning off a cooling/heating function.

The temperature adjusting part 113 preferably includes a thermostat rotationally operated to enable an adjustment of the temperature of the blown air step by step. Optionally, while the cooling/heating function of the air conditioner is turned off, it is able to perform a function of blowing the indoor air only via an operation of the temperature adjusting part 113. In doing so, the blown airflow can be selectively changed into ‘High’ and ‘Low’ by the operation of the operational mode part 110.

Meanwhile, to be operative in controlling the blown airflow and power source supply, the operational mode part 110 preferably includes a fan regulating part 112 and a power supply part 111.

In this case, the fan regulating part 112 is operated to control a rotational speed of the fan for adjusting the airflow rate of the air blown into an indoor space. So, a current speed and airflow rate of the air blown from the air conditioner can be controller. In this case, it is preferable that the fan regulating part 112 includes a rocker switch to enable the fan speed to be divided into two steps of ‘High’ and ‘Low’ for fast and slow fan speed.

And, the power supply part 111 is operated to turn on/off a supply of the power to the air conditioner. Preferably, the power supply part 111 includes a rocker switch turned on/off to control the power supply to the air conditioner.

Meanwhile, a compressor COMP and a motor MOTOR, as shown in FIG. 6, are provided within the air conditioner. The motor is connected to enable a rotation of the fan. And, a voltage or current supplied to the compressor COMP or motor MOTOR is regulated via an operation of the input part (30 in FIG. 5). So, the air conditioner is driven to control the air-conditioned air is blown into the indoor space.

In doing so, the rocker switch SW1 of the power supply part 111 is turned on/off to control the supply of the power. And, the airflow rate of the blown air can be changed into two steps of ‘High’ and ‘Low’. As the switch SW2 is brought into contact with a connecting point ‘HI’ or ‘LOW’, the current supplied to the motor is varied to change the rotational speed of the fan. Hence, the airflow rate is controlled to lie in a high or low state.

The rocker switch SW2 of the fan regulating part 112 always keeps being connected to the motor in both of the high and low steps. Hence, once the power supply part 111 keeps being turned on, the power is always supplied to the motor MOTOR via one of the two connecting points HI and LOW.

Namely, if the rocker switch SW1 of the power supply part 111 is turned on to supply the power to the air conditioner, the fan can be always driven via one of the high and low steps without a separate switch operation conducted by a user.

Meanwhile, the thermostat TH of the temperature adjusting part 113 is connected to the rocker switch SW1 of the power supply part 111 and to the compressor COMP, simultaneously. Hence, the temperature of the blown air can be adjusted as the current supplied to the compressor COMP is controlled.

Thus, since the temperature adjusting part 113 and the fan regulating part 112 include the thermostat TH and the rocker switch SW2, respectively, the air conditioner can be instantly driven without a separate operation if the power is supplied to the air conditioner.

Moreover, since the fan regulating part 112 and the power supply part 111 include the rocker switches SW1 and SW2 having relatively small volumes, respectively, a size of the input part 130 can be reduced. Hence, a space occupied by the input part 130 within the air conditioner is decreased to enable an efficient utilization of the inner space of the air conditioner.

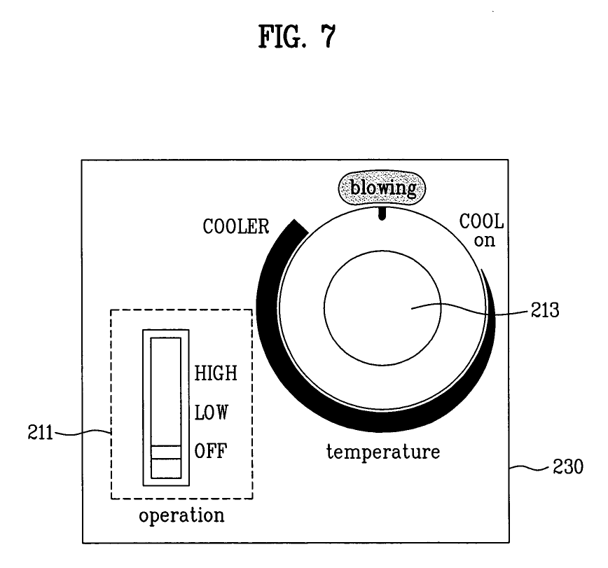

An air conditioner according to a fourth embodiment of the present invention is explained with reference to FIG. 7 as follows.

FIG. 7 is a layout of an input part of a control panel according to a fourth embodiment of the present invention.

Referring to FIG. 7, an input part of a control panel according to a fourth embodiment of the present invention includes a temperature adjusting part 213 and an operational mode part 211. A configuration and operation of the temperature adjusting part 213 is the same of those of the third embodiment of the present invention, of which description is skipped in the following.

The operational mode part 211 preferably includes a slide switch that is vertically slidable to select an operation of the air conditioner. By operating the slide switch, power supply to the air conditioner or a speed variation of a fan can be carried out.

In particular, it is preferable that an operational state of the air conditioner is selectively changed into a step of ‘OFF’, ‘LOW’ or ‘HIGH’ by an operation of the operational mode part 211. In the step OFF, the operation of the air conditioner stops. In the step LOW, the fan is driven at a low speed. In the step HIGH, the fan is driven at a high speed.

It is a matter of course that the slide switch can be arranged horizontally instead of the vertical arrangement. In case of being horizontally arranged, the slide switch can be operated in right-to-left directions.

Accordingly, the present invention has the following effects or advantages.

First of all, as the display part of the air conditioner includes a plurality of the sub-display parts and each of the sub-display parts includes a plurality of the LEDs, the overall operational state of the air conditioner can be represented via the LEDs. Hence, the LEDs are turned on to facilitate a user to recognize the state of the air conditioner without any separate operation.

Secondly, since the input part of the air conditioner includes the efficient combination between the rocker or slide switch and the thermostat, the air conditioner can be easily driven with one operation only. Hence, the input part of the air conditioner can considerably enhance the convenience of using the air conditioner. And, the inner space of the air conditioner can be more efficiently utilized since the size of the input part is reduced.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. An air conditioner comprising:
an input part to which a control signal for an operation of the air conditioner is inputted;
a display part having at least one sub-display part displaying an operational state of the air conditioner; and
a microcomputer controlling the air conditioner to be operated according to the control signal generated from the input part, the microcomputer controlling the operational state of the air conditioner to be displayed via the display part.

2. The air conditioner of claim 1, wherein the at least one sub-display part comprises a plurality of LEDs and wherein each of the LEDs is turned on to correspond to the operational state of the air conditioner.

3. The air conditioner of claim 2, wherein the LEDs are sequentially turned on according to the operational state of the air conditioner.

4. The air conditioner of claim 1, further comprising a remote controller receiving part receiving the control signal transmitted from a remote controller.

5. The air conditioner of claim 4, the microcomputer comprising:
an input control part controlling the operation of the air conditioner according to the control signal transferred from at least one of the input part and the remote controller receiving part; and
a display control part controlling the operational state of the air conditioner to be displayed via the display part.

6. The air conditioner of claim 1, the display part comprising:
a temperature sub-display part displaying a temperature of a blown air set in the air conditioner;
a time sub-display part displaying a reservation time set in the air conditioner; and
an operational mode sub-display part displaying an operational mode set in the air conditioner.

7. The air conditioner of claim 1, the input part comprising at least one button wherein the input part is controlled to change the operational state of the air conditioner according to a count of pressing the button.

8. The air conditioner of claim 1, the input part comprising:
a temperature adjusting part operated to control a temperature of an air blown from the air conditioner; and
an operational mode part operated to control a blow airflow rate and power supply of the air conditioner.

9. The air conditioner of claim 8, the temperature adjusting part comprising a thermostat operated to control the temperature by being rotated.

10. The air conditioner of claim 8, the operational mode part comprising a slide switch allowing the operation of the air conditioner to be selected.

11. The air conditioner of claim 8, the operational mode part comprising:
a fan regulating part operated to control a rotational speed of a fan for controlling an airflow rate blown into an indoor space; and
a power supply part operated to turn on/off a power supply to the air conditioner.

12. The air conditioner of claim 11, wherein each of the power supply part and the fan regulating part comprises a rocker switch.

13. The air conditioner of claim 11, wherein if the power supply part is turned on, the fan is driven at either a high step or a low step.

14. An air conditioner comprising:
a temperature adjusting part operated to adjust a current supplied to a compressor for a control of an air blown from the air conditioner and a selection of a blower function; and
an operational mode part operated to control a blown airflow rate and a power supply of the air conditioner.

15. The air conditioner of claim 14, the temperature adjusting part comprising a thermostat operated to control the temperature by being rotated.

16. The air conditioner of claim 14, the operational mode part comprising a slide switch slidable to allow the operation of the air conditioner to be selected.

17. The air conditioner of claim 16, the operational mode part comprising:
a fan regulating part operated to control a rotational speed of a fan for controlling an airflow rate blown into an indoor space; and
a power supply part operated to turn on/off a power supply to the air conditioner.

18. The air conditioner of claim 17, wherein each of the power supply part and the fan regulating part comprises a rocker switch.

19. The air conditioner of claim 17, wherein if the power supply part is turned on, the fan is driven at either a high step or a low step.
